(19) United States
(12) Patent Application Publication
(10) Pub. No.: US 2026/0292341 A1
(43) Pub. Date: Sep. 24, 2026

(54) ELECTRONIC DEVICE THAT PERFORM CONTROL TO EXECUTE SIMULATION REGARDING IMAGE CAPTURING BY IMAGING DEVICE

(71) Applicant: CANON KABUSHIKI KAISHA, Tokyo (JP)

(72) Inventor: SEIJI OGAWA, Tokyo (JP)

(21) Appl. No.: 19/571,127

(22) Filed: Mar. 18, 2026

(30) Foreign Application Priority Data
Mar. 21, 2025 (JP) 2025-046611

(51) Int. Cl. H04N 23/69; H04N 23/63; H04N 23/67; H04N 23/88

(52) U.S. Cl. CPC H04N 23/69; H04N 23/635; H04N 23/67; H04N 23/88

(57) ABSTRACT

An electronic device includes a processor, and a memory storing a program which, when executed by the processor, causes the electronic device to execute control processing of performing control, in response to a user operation, to execute a simulation regarding main image capturing by an imaging device, wherein in the control processing, control is performed in response to a first user operation to execute a first simulation of performing preliminary image capturing with an exposure parameter to be applied during main image capturing in a case where a trajectory of a change in an angle of view of the imaging device applied during the main image capturing is not set, and to execute a second simulation of changing the angle of view of the imaging device according to the trajectory in a case where the trajectory is set.

This application claims the benefit of Japanese Patent Application No. 2025-046611, filed Mar. 21, 2025, which is hereby incorporated by reference herein in its entirety.

### BACKGROUND

### Field of the Technology

The present disclosure relates to an electronic device, and more particularly to an imaging device capable of performing time-lapse image capturing and motion time-lapse image capturing.

### Description of the Related Art

Gimbal cameras in which a camera and a gimbal are integrated have been proposed. Many gimbal cameras are small in size. Although a small gimbal camera has few operation members and the like, in many cases, operation members corresponding to the operation members of a conventional gimbal that is not integrated with a camera are provided so as to improve usability of the gimbal camera by a user of the conventional gimbal.

Many gimbal cameras can often perform time-lapse image capturing and motion time-lapse image capturing in addition to normal still image capturing and normal moving image capturing. In both the time-lapse image capturing and the motion time-lapse image capturing, still image capturing is performed a plurality of times at constant time intervals, and one moving image is generated by combining a plurality of obtained still images. However, the time-lapse image capturing is performed with a fixed angle of view, whereas the motion time-lapse image capturing is performed while varying the angle of view.

Time-lapse image capturing and motion time-lapse image capturing are similar in that, for both, still image capturing is performed a plurality of times at regular time intervals, and one moving image is generated by combining a plurality of obtained still images. Therefore, many setting items necessary for time-lapse image capturing are common to setting items necessary for motion time-lapse image capturing. Therefore, from the viewpoint of operability, it is preferable to provide one common image capturing mode without providing two individual image capturing modes as an image capturing mode for performing time-lapse image capturing and an image capturing mode for performing motion time-lapse image capturing.

International Publication No. 2009/025345 discloses a technique in which time-lapse image capturing and motion time-lapse image capturing are performed in the same image capturing mode, and a test (simulation) is performed before main image capturing.

In the technique disclosed in International Publication No. 2009/025345, a simulation of time-lapse image capturing and a simulation of motion time-lapse image capturing are performed in response to the same user operation, and the same simulation is performed as these simulations. However, because important check items in time-lapse image capturing and important check items in motion time-lapse image capturing are different, the technique disclosed in International Publication No. 2009/025345 cannot efficiently perform the simulation (time-lapse image capturing or motion time-lapse image capturing) regarding main image capturing. For example, during the simulation, necessary confirmation cannot be performed or unnecessary confirmation is performed. Although it is conceivable to perform the simulation of time-lapse image capturing and the simulation of motion time-lapse image capturing in response to different user operations, the user operation becomes complicated, and the simulation (time-lapse image capturing or motion time-lapse image capturing) regarding main image capturing cannot be efficiently performed. In addition, it is difficult to increase the number of operation members in a small gimbal camera.

### SUMMARY

The present disclosure provides a technique capable of efficiently performing a simulation regarding main image capturing.

An electronic device includes a processor, and a memory storing a program which, when executed by the processor, causes the electronic device to execute control processing of performing control, in response to a user operation, to execute a simulation regarding main image capturing by an imaging device, wherein in the control processing, control is performed in response to a first user operation to execute a first simulation of performing preliminary image capturing with an exposure parameter to be applied during main image capturing in a case where a trajectory of a change in an angle of view of the imaging device applied during the main image capturing is not set, and to execute a second simulation of changing the angle of view of the imaging device according to the trajectory in a case where the trajectory is set.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are external views illustrating a digital camera.

FIG. 2 is a block diagram illustrating a configuration of the digital camera.

FIG. 3 is a flowchart of image capturing mode processing.

FIG. 4 is a flowchart of trajectory setting processing.

FIG. 5 is a flowchart of simulation processing.

FIG. 6 is a flowchart of simulation processing.

FIG. 7 is a flowchart of image capturing mode processing.

FIGS. 8A to 8F are schematic views of a display screen.

### DESCRIPTION OF THE EMBODIMENTS

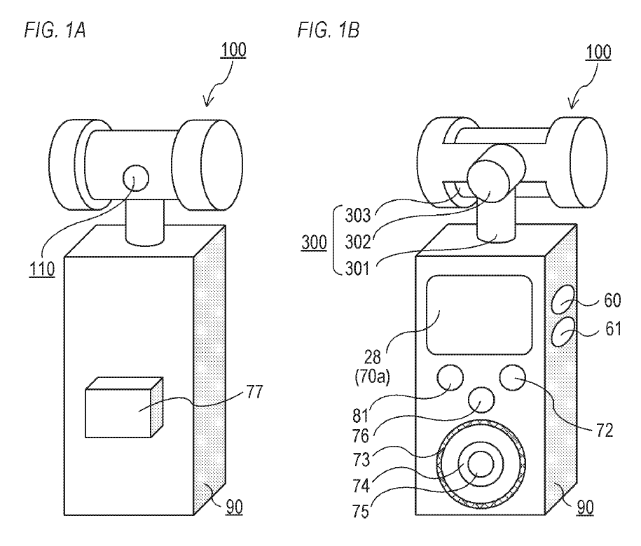

Hereinafter, an embodiment of the present disclosure will be described with reference to the drawings. FIGS. 1A and 1B are external views of a digital camera 100 (imaging device) as an example of a device (electronic device) to which the present disclosure can be applied. FIG. 1A is a front perspective view illustrating the digital camera 100, and FIG. 1B is a back perspective view illustrating the digital camera 100. The digital camera 100 is a digital camera including a gimbal mechanism.

The digital camera 100 includes a grip unit 90, an imaging unit 110, and an orientation control unit 300. The imaging unit 110 is disposed so as to be able to change its orientation with respect to the grip unit 90. The orientation control unit 300 includes a pan shaft drive unit 301, a roll shaft drive unit 302, and a tilt shaft drive unit 303. The pan shaft drive unit 301 is fixed to the grip unit 90, and the tilt shaft drive unit 303 is fixed to the imaging unit 110. By driving (rotating) at least one of the pan shaft drive unit 301, the roll shaft drive unit 302, and the tilt shaft drive unit 303, the orientation of the imaging unit 110 with respect to the grip unit 90 can be maintained or changed. The grip unit 90 and the orientation control unit 300 may be separable, or the imaging unit 110 and the orientation control unit 300 may be separable. In a case where the imaging unit 110 and the orientation control unit 300 are separable, the imaging unit 110 may be a smartphone, an action camera, or the like.

A display unit 28 displays images and various types of information. A touch panel 70a can detect a touch operation on a display surface (touch operation surface) of the display unit 28. A shutter button 61 is an operation member for giving an image capturing instruction. A mode selector switch 60 is an operation member for switching among various modes. A power switch 72 is an operation member for switching a power supply of the digital camera 100 between ON and OFF.

A controller wheel 73 is a rotatable operation member, and is used, for example, to instruct (select) a selection item. When a rotation operation of the controller wheel 73 is performed, an electrical pulse signal is generated according to an operation amount (rotation amount), and each unit (the display unit 28 or the like) of the digital camera 100 is controlled on the basis of the pulse signal. An angle and a rotation speed of the rotation operation for the controller wheel 73 can be determined by the pulse signal. The controller wheel 73 only needs to be an operation member capable of detecting a rotation operation, and may be, for example, a dial operation member in which the controller wheel 73 itself rotates according to the rotation operation to generate a pulse signal. The controller wheel 73 may be an operation member (so-called touch wheel) including a touch sensor, or may be an operation member that detects a rotational motion of a user's finger on the controller wheel 73 without rotation of the controller wheel 73 itself.

A joystick 74 is an operation member disposed on a front surface side (a back surface side of the digital camera 100 and a user side) of the grip unit 90, and it is assumed that the joystick 74 is operated with a thumb of a hand gripping the grip unit 90 (grip). The joystick 74 is configured to be able to be pushed in a plurality of directions such as an upper direction, a lower direction, a left direction, and a right direction, and can perform processing according to the direction in which the joystick 74 is pushed. A joystick center button 75 is a push button and is mainly used to determine a selection item. A moving image button 76 is a push button and is used for executing an instruction to start or stop moving image capturing (recording). A trigger button 77 is an operation member disposed on the back surface side (the front surface side and an object side of the digital camera 100) of the grip unit 90, and it is assumed that the trigger button 77 is operated with an index finger of the hand gripping the grip unit 90 (grip). A menu button 81 is a push button used to execute an instruction operation of displaying a menu screen. When the menu button 81 is pressed, a menu screen on which various settings can be executed is displayed on the display unit 28. The user can intuitively perform various settings using the menu screen displayed on the display unit 28, the joystick 74, and the joystick center button 75.

Operations of the digital camera 100 include the following.
Changing an angle of view (changing the orientation of the imaging unit 110) performed in response to a user operation on the joystick 74.
Switching of a gimbal mode performed in response to short pressing of the trigger button 77.
Switching to a lock mode performed in response to holding (pressing and holding) of the trigger button 77.
Returning to the origin of the angle of view, and switching of an image capturing direction between a selfie direction and a non-selfie direction performed in response to double-clicking or triple-clicking (consecutive tapping) of the trigger button 77.

When the user changes the orientation of the grip unit 90, the orientation control unit 300 smoothly changes the angle of view (the orientation of the imaging unit 110) on the basis of the set gimbal mode (rule). For example, the following gimbal modes can be set.

Pan-follow mode (PF mode): The angle of view (the orientation of the imaging unit 110) is caused to follow the change in the orientation of the grip unit 90 in a pan direction, and the angle of view (the orientation of the imaging unit 110) is fixed in a tilt direction and a roll direction. The PF mode is used when a horizontally moving object is tracked.

Lock mode: The angle of view (the orientation of the imaging unit 110) is fixed in all of the pan direction, the tilt direction, and the roll direction. The lock mode is used when image capturing continues in a specific direction.

Follow mode: The angle of view (the orientation of the imaging unit 110) is caused to follow the change in the orientation of the grip unit 90 in the pan direction and the tilt direction, and the angle of view (the orientation of the imaging unit 110) is fixed in the roll direction. The follow mode is used when it is desired to realize natural camerawork.

Point of view (POV) mode: The angle of view (the orientation of the imaging unit 110) is caused to follow the change in the orientation of the grip unit 90 in all of the pan direction, the tilt direction, and the roll direction. The POV mode is used when it is desired to perform dynamic image capturing or greatly change the viewpoint.

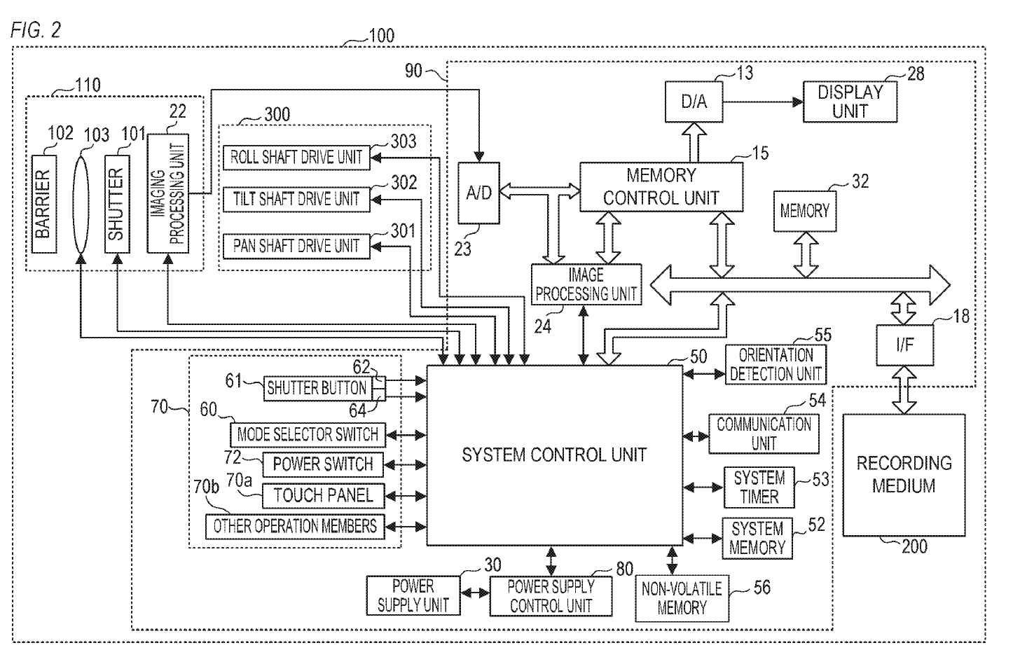

FIG. 2 is a block diagram illustrating a configuration of the digital camera 100.

An imaging lens 103 is a lens group including a zoom lens and a focus lens. A shutter 101 is a shutter having an aperture function. An imaging processing unit 22 is an imaging element (image sensor) constituted by a CCD, a CMOS element, or the like that converts an optical image into an electrical signal. An A/D converter 23 converts an analog signal (the electrical signal) output from the imaging processing unit 22 into a digital signal. A barrier 102 covers an imaging system including the imaging lens 103, the shutter 101, and the imaging processing unit 22 of the digital camera 100, thereby preventing contamination or damage of the imaging system.

An image processing unit 24 performs predetermined processing (such as pixel interpolation, resizing processing such as shrinking, and color conversion processing) on data (the digital signal) from the A/D converter 23 or data from a memory control unit 15. In addition, the image processing unit 24 performs predetermined calculation processing by using captured image data, and a system control unit 50 performs exposure control and distance measurement control on the basis of a result of the calculation obtained by the image processing unit 24. As a result, through-the-lens (TTL)-type autofocus (AF) processing, auto exposure (AE) processing, and flash pre-flash (EF) processing are performed. The image processing unit 24 further executes predetermined calculation processing by using the captured image data and executes TTL-type auto white balance (AWB) processing on the basis of the obtained calculation result.

The memory control unit 15 controls transmission and reception of data among the A/D converter 23, the image processing unit 24, and a memory 32. Output data from the A/D converter 23 is written into the memory 32 via the image processing unit 24 and the memory control unit 15. Alternatively, the output data from the A/D converter 23 is written into the memory 32 via the memory control unit 15 without intervention of the image processing unit 24. The memory 32 stores image data that is obtained by the imaging processing unit 22 and is converted into digital data by the A/D converter 23 and image data to be displayed on the display unit 28. The memory 32 has a storage capacity that is sufficient for storing a predetermined number of still images and moving images and voice in a predetermined period of time. The memory 32 also serves as a memory (video memory) for image display. A D/A converter 13 converts image data that is to be displayed and is stored in the memory 32 into an analog signal and supplies the analog signal to the display unit 28. Thus, the image data that is to be displayed and is written into the memory 32 is displayed by the display unit 28 via the D/A converter 13.

The display unit 28 is a display such as an LCD or an organic EL and performs display corresponding to an analog signal from the D/A converter 13. A digital signal that is A/D converted by the A/D converter 23 and is accumulated in the memory 32 is converted into an analog signal in the D/A converter 13, and the analog signal is sequentially transferred to and displayed on the display unit 28, whereby live view display (LV display) can be performed. Hereinafter, an image displayed in the live view display is referred to as a live-view image (LV image).

A non-volatile memory 56 is a memory as an electrically erasable and recordable recording medium, and is, for example, an EEPROM. In the non-volatile memory 56, constants, a program, and the like for an operation of the system control unit 50 are stored. The program as used herein is a computer program for executing the processing illustrated in the various flowcharts described later. The system control unit 50 is a control unit including at least one processor and/or at least one circuit and controls the entire digital camera 100. The system control unit 50 implements processing described later by executing the program stored in the non-volatile memory 56. A system memory 52 is, for example, a RAM, and the system control unit 50 loads the constants, variables, and the program read from the non-volatile memory 56 for the operation of the system control unit 50 into the system memory 52. In addition, the system control unit 50 also performs display control by controlling the memory 32, the D/A converter 13, the display unit 28, and the like.

A system timer 53 is a timer unit that counts time used for various controls and time of an embedded clock.

A communication unit 54 transmits and receives a video signal and a voice signal to and from an external device connected wirelessly or via a wired cable. The communication unit 54 can also be connected to a wireless local area network (LAN) and the Internet. In addition, the communication unit 54 can communicate with an external device also via Bluetooth (registered trademark) or Bluetooth Low Energy. The communication unit 54 can transmit an image captured by the imaging processing unit 22 (including an LV image) and an image recorded in a recording medium 200, and can receive image data and other various types of information from an external device.

An orientation detection unit 55 detects an orientation of the grip unit 90 with respect to the direction of gravity. On the basis of the orientation detected by the orientation detection unit 55, it can be determined whether an image captured by the imaging processing unit 22 is an image captured with the grip unit 90 held horizontally or vertically. The system control unit 50 can add orientation information corresponding to the orientation detected by the orientation detection unit 55 to an image file of the image captured by the imaging processing unit 22, or rotate and record the image. In addition, the system control unit 50 can maintain the orientation of the imaging unit 110 with respect to the direction of gravity by operating the orientation control unit 300 on the basis of information of an orientation change detected by the orientation detection unit 55. The system control unit 50 can also change the orientation of the imaging unit 110 while suppressing a sudden orientation change of the imaging unit 110. For example, an acceleration sensor, a gyro sensor, or the like can be used for the orientation detection unit 55. It is also possible to detect a movement of the grip unit 90 (whether or not the grip unit 90 is panning, tilting, rolling, lifting, stationary, or the like) by using an acceleration sensor or a gyro sensor which is the orientation detection unit 55.

A power supply control unit 80 includes a battery detection circuit, a DC-DC converter, a switch circuit that switches a block to be energized, and the like, and detects whether or not a battery is mounted, the type of battery, a remaining battery level, and the like. In addition, the power supply control unit 80 controls the DC-DC converter on the basis of a result of the detection and an instruction from the system control unit 50, and supplies a required voltage to portions including the recording medium 200 for a necessary period of time. A power supply unit 30 includes a primary battery such as an alkaline battery or a lithium battery, a secondary battery such as a NiCd battery, a NiMH battery, or a Li battery, an AC adapter, or the like.

A recording medium I/F 18 is an interface to the recording medium 200 such as a memory card or a hard disk. The recording medium 200 is a recording medium such as a memory card for recording captured images, and is constituted by a semiconductor memory, an optical disk, a magnetic disk, or the like.

An operation unit 70 is an input unit that receives an operation from the user (user operation) and is used for inputting various operation instructions to the system control unit 50. Functions are appropriately assigned to operation members of the operation unit 70 for each image capturing scene by, for example, selecting and operating various function icons displayed on the display unit 28 (the operation members of the operation unit 70 are programmable), and the operation members of the operation unit 70 act as various function buttons. Examples of the function buttons include an end button, a return button, an image feed button, a jump button, a narrowing button, and an attribute change button. These function buttons are included within other operation members 70b shown in FIG. 2

As illustrated in FIG. 2, the operation unit 70 includes the mode selector switch 60, the shutter button 61, the power switch 72, the touch panel 70a, the other operation members 70b, and the like. The other operation members 70b include the controller wheel 73, the joystick 74, the joystick center button 75, the moving image button 76, the trigger button 77, the menu button 81, and the like.

The mode selector switch 60 switches an operation mode of the system control unit 50 to any one of a still image recording mode, a moving image recording mode, a playback mode, or the like. The still image recording mode includes modes such as an auto image capturing mode, an auto scene determination mode, a manual mode, an aperture-priority mode (Av mode), a shutter-speed priority mode (Tv mode), and a program AE mode (P mode). In addition, the still image recording mode also includes various scene modes that include image capturing settings for different image capturing scenes, a custom mode, and the like. The user can directly switch the operation mode to any one of these modes with the mode selector switch 60. Alternatively, the user may temporarily switch a screen to an image capturing mode list screen with the mode selector switch 60 and then selectively switch the mode to any one of the plurality of displayed modes with another operation member. Similarly, the moving image recording mode may include a plurality of modes.

The shutter button 61 includes a first shutter switch 62 and a second shutter switch 64. The first shutter switch 62 is turned on in the middle of an operation of the shutter button 61 in response to a so-called half-press (image capturing preparation instruction) and generates a first shutter switch signal SW1. The system control unit 50 starts an image capturing preparation operation such as autofocus (AF) processing, automatic exposure (AE) processing, automatic white balance (AWB) processing, or flash pre-flash (EF) processing with the first shutter switch signal SW1. The second shutter switch 64 is turned on at completion of the operation of the shutter button 61 in response to a so-called full-press (image capturing instruction) and generates a second shutter switch signal SW2. The system control unit 50 starts a series of image capturing processing operations from reading a signal from the imaging processing unit 22 to writing a captured image as an image file into the recording medium 200 with the second shutter switch signal SW2.

The touch panel 70a is a touch sensor that detects any of various touch operations on the display surface of the display unit 28 (the operation surface of the touch panel 70a). The touch panel 70a and the display unit 28 can be integrally configured. For example, the touch panel 70a is configured so that transmittance of light does not hinder display of the display unit 28 and is attached to an upper layer of the display surface of the display unit 28. Then, input coordinates on the touch panel 70a are associated with display coordinates on the display surface of the display unit 28. As a result, it is possible to provide a graphical user interface (GUI) configured as if the user can directly operate a screen displayed on the display unit 28.

The system control unit 50 can detect the following operations on the touch panel 70a or the following states of the touch panel 70a.

An operation in which a finger or a pen that is not touching the touch panel 70a newly touches the touch panel 70a, that is, a start of a touch (hereinafter, referred to as touch-down)

A state in which a finger or a pen is touching the touch panel 70a (hereinafter, referred to as touch-on)

An operation in which a finger or a pen is moving while touching the touch panel 70a (hereinafter, referred to as touch-move)

An operation in which a finger or a pen that is touching the touch panel 70a is released from the touch panel 70a, that is, an end of the touch (hereinafter, referred to as touch-up)

A state in which nothing touches the touch panel 70a (hereinafter, referred to as touch-off)

When the touch-down is detected, the touch-on is detected at the same time. After the touch-down, the touch-on is continuously detected normally unless the touch-up is detected. Also, when the touch-move is detected, the touch-on is continuously detected. Even if the touch-on is detected, the touch-move is not detected as long as the touch position is not moved. After the touch-up of all the fingers and the pens that have touched the touch panel is detected, the state transitions to touch-off.

The system control unit 50 is notified of these operations and states and position coordinates touched by a finger or a pen on the touch panel 70a via an internal bus. Then, the system control unit 50 determines, on the basis of the notified information, what kind of operation (touch operation) has been executed on the touch panel 70a. With regard to the touch-move, a movement direction of a finger or a pen moving on the touch panel 70a can be determined on the basis of a change in the position coordinates for each vertical component and for each horizontal component on the touch panel 70a. When the touch-move for a predetermined distance or more is detected, it is determined that a sliding operation has been performed. An operation of quickly moving a finger by a certain distance while touching the touch panel 70a and then releasing the finger from the touch panel 70a is referred to as a flick. In other words, the flick is an operation of quickly tracing the touch panel 70a so as to flick the touch panel 70a with a finger. When the touch-move at a predetermined speed or higher for a predetermined distance or more is detected and then the touch-up is detected, it can be determined that a flick has been executed (it can be determined that a flick has been executed following the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinch operation (or simply referred to as pinch). The touch panel 70a may be any type of touch panel among various types such as a resistive film type, a capacitance type, a surface acoustic wave type, an infrared light type, an electromagnetic induction type, an image recognition type, and an optical sensor type. Although there are types including a type in which a touch is detected due to contact with the touch panel and a type in which a touch is detected due to approach of a finger or a pen to the touch panel, either of these types may be used.

The digital camera 100 can perform time-lapse image capturing, motion time-lapse image capturing, and simulations thereof. In both time-lapse image capturing and motion time-lapse image capturing, still image capturing is performed a plurality of times at constant time intervals, and one moving image is generated by combining a plurality of obtained still images. The moving image is not necessarily generated. However, time-lapse image capturing is performed with a fixed angle of view, whereas motion time-lapse image capturing is performed while varying the angle of view.

The digital camera 100 can perform time-lapse image capturing, motion time-lapse image capturing, and simulations thereof in the same image capturing mode in order to improve operability. Time-lapse image capturing and motion time-lapse image capturing are performed in response to the same user operation. Furthermore, simulation of time-lapse image capturing and simulation of motion time-lapse image capturing are performed in response to the same user operation.

Here, important check items in time-lapse image capturing are different from important check items in motion time-lapse image capturing. Exposure is important in time-lapse image capturing, and a change in the angle of view is important in motion time-lapse image capturing.

Therefore, in the present embodiment, in a case where a trajectory of the change in the angle of view applied during main image capturing is not set (in a case where time-lapse image capturing is performed as main image capturing), a simulation of performing preliminary image capturing with an exposure parameter to be applied during main image capturing is executed. Then, in a case where the trajectory is set (in a case where motion time-lapse image capturing is performed as main image capturing), a simulation of changing the angle of view according to the trajectory is executed. In this way, it is possible to efficiently (suitably) perform the simulation regarding main image capturing.

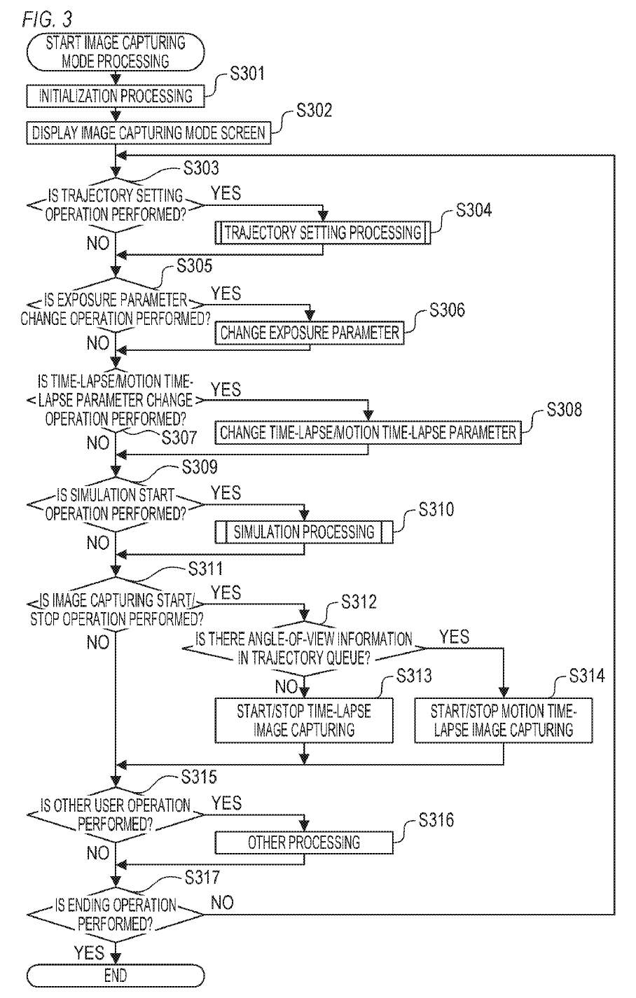

FIG. 3 is a flowchart of image capturing mode processing performed by the digital camera 100. The image capturing mode processing illustrated in FIG. 3 is implemented by the system control unit 50 loading a program stored in the non-volatile memory 56 into the system memory 52 and executing the program. For example, when an image capturing mode is set, the system control unit 50 starts the image capturing mode processing of FIG. 3.

In S301, the system control unit 50 initializes a flag, a control variable, or the like.

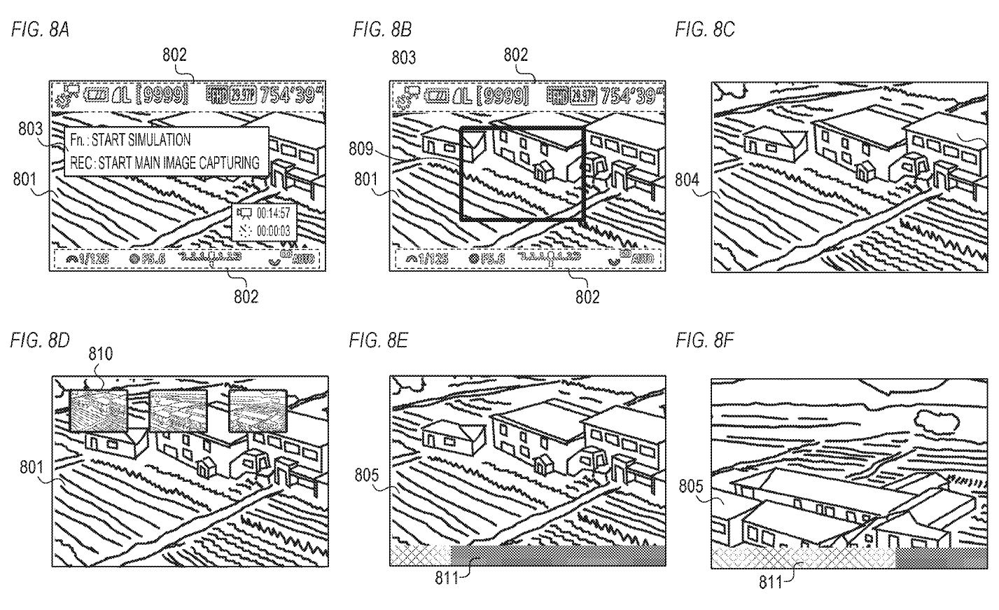

In S302, the system control unit 50 displays an image capturing mode screen on the display unit 28. For example, the system control unit 50 displays a live-view image on the display unit 28, and displays camera information indicating a camera setting value (image capturing parameter) and the like superimposed on the live-view image. FIG. 8A is a schematic view illustrating an example of the image capturing mode screen. Camera information 802 and an operation guide 803 are superimposed on a live-view image 801. The operation guide 803 indicates a user operation specific to time-lapse image capturing or motion time-lapse image capturing.

In S303, the system control unit 50 determines whether or not a user operation (trajectory setting start operation) for instructing the operation unit 70 to start a trajectory setting is performed. If the trajectory setting start operation is performed, the processing proceeds to S304. Otherwise, the processing proceeds to S305.

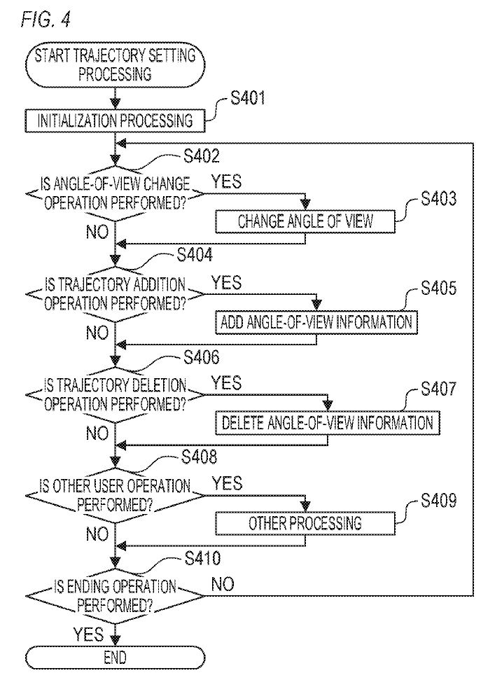

In S304, the system control unit 50 performs trajectory setting processing. Details of the trajectory setting processing will be described later with reference to FIG. 4.

In S305, the system control unit 50 determines whether or not a user operation (exposure parameter change operation) for instructing the operation unit 70 to change an exposure parameter is performed. If the exposure parameter change operation is performed, the processing proceeds to S306. Otherwise, the processing proceeds to S307.

In S306, the system control unit 50 changes the exposure parameter according to the exposure parameter change operation. The exposure parameter is, for example, an aperture value, a shutter speed, an ISO sensitivity, an exposure correction parameter, or the like.

In S307, the system control unit 50 determines whether or not a user operation (time-lapse/motion time-lapse parameter change operation) for instructing the operation unit 70 to change a setting value (parameter) specific to time-lapse image capturing or motion time-lapse image capturing is performed. If the time-lapse/motion time-lapse parameter change operation is performed, the processing proceeds to S308. Otherwise, the processing proceeds to S309.

In S308, the system control unit 50 changes the parameter specific to time-lapse image capturing or motion time-lapse image capturing according to the time-lapse/motion time-lapse parameter change operation. The specific parameter may be an image capturing interval, the number of image capturing times, an image capturing time, an image capturing start time, presence or absence of autofocus processing for each still image capturing, presence or absence of automatic exposure processing for each still image capturing, an image (a recording format of a still image or a moving image), or presence or absence of lighten composite processing. The image capturing interval is a time interval of the still image capturing, and the number of image capturing times is the number of times of the still image capturing. The image capturing time is the total time for performing the time-lapse image capturing or the motion time-lapse image capturing, and the image capturing start time is a start time of the time-lapse image capturing or the motion time-lapse image capturing (first still image capturing).

In S309, the system control unit 50 determines whether or not a user operation (simulation start operation) for instructing the operation unit 70 to start a simulation is performed. If the simulation start operation is performed, the processing proceeds to S310. Otherwise, the processing proceeds to S311.

In S310, the system control unit 50 performs simulation processing. Details of the simulation processing will be described later with reference to FIG. 5.

In S311, the system control unit 50 determines whether or not a user operation (image capturing start/stop operation) for instructing the operation unit 70 to start or stop main image capturing is performed. If the image capturing start/stop operation is performed, the processing proceeds to S312. Otherwise, the processing proceeds to S315.

In S312, the system control unit 50 determines whether or not one or more pieces of angle-of-view information are included in a trajectory queue (whether or not a trajectory of an angle-of-view change is set). The angle-of-view information is information indicating an angle of view, and the trajectory queue indicates the trajectory of the angle-of-view change by indicating one or more pieces of angle-of-view information in time series. When one or more pieces of angle-of-view information are included in the trajectory queue (the trajectory is set), the processing proceeds to S314. Otherwise, the processing proceeds to S313.

In S313, the system control unit 50 starts or stops the time-lapse image capturing. The time-lapse image capturing is started in response to the image capturing start/stop operation in a case where time-lapse image capturing is not being performed, and the time-lapse image capturing is stopped in response to the image capturing start/stop operation in a case where time-lapse image capturing is being performed.

In S314, the system control unit 50 starts or stops the motion time-lapse image capturing. The motion time-lapse image capturing is started in response to the image capturing start/stop operation in a case where motion time-lapse image capturing is not being performed, and the motion time-lapse image capturing is stopped in response to the image capturing start/stop operation in a case where motion time-lapse image capturing is being performed.

In S315, the system control unit 50 determines whether or not another user operation is performed on the operation unit 70. If another user operation is performed, the processing proceeds to S316. Otherwise, the processing proceeds to S317.

In S316, the system control unit 50 performs processing according to the other user operation. For example, the system control unit 50 causes the screen (display screen) displayed on the display unit 28 to transition from the image capturing mode screen to the menu screen.

In S317, the system control unit 50 determines whether or not a user operation (ending operation) for instructing the operation unit 70 to end the image capturing mode processing is performed. If the ending operation is performed, the image capturing mode processing is ended. Otherwise, the processing proceeds to S303. The ending operation is a user operation for instructing switching to another operation mode (such as the playback mode), a user operation for instructing turning off of the digital camera 100, or the like.

FIG. 4 is a flowchart of the trajectory setting processing performed in S304 of FIG. 3.

In S401, the system control unit 50 initializes a flag, a control variable, or the like. At this time, a GUI (such as an icon) indicating that the trajectory setting processing is in progress may be displayed on the display unit 28.

In S402, the system control unit 50 determines whether or not a user operation (angle-of-view change operation) for instructing the operation unit 70 to change the angle of view is performed. If the angle-of-view change operation is performed, the processing proceeds to S403. Otherwise, the processing proceeds to S404.

In S403, the system control unit 50 changes the angle of view according to the angle-of-view change operation. The angle-of-view change operation may be a user operation on the joystick 74 as in the case of a general gimbal, or it may be a user operation on another operation member.

In S404, the system control unit 50 determines whether or not a user operation (trajectory addition operation) for instructing the operation unit 70 to add angle-of-view information to the trajectory queue is performed. If the trajectory addition operation is performed, the processing proceeds to S405. Otherwise, the processing proceeds to S406.

In S405, the system control unit 50 adds angle-of-view information indicating a current angle of view to the trajectory queue. The angle-of-view information is added to the trajectory queue on the basis of the first-in, first-out (FIFO) rule. Therefore, when a plurality of pieces of angle-of-view information are included in the trajectory queue, the plurality of pieces of angle-of-view information are arranged in order from one added to the trajectory queue at an earlier timing. The angle-of-view information may be added to the trajectory queue on the basis of another rule.

In S406, the system control unit 50 determines whether or not a user operation (trajectory deletion operation) for instructing the operation unit 70 to delete angle-of-view information from the trajectory queue is performed. If the trajectory deletion operation is performed, the processing proceeds to S407. Otherwise, the processing proceeds to S408.

In S407, the system control unit 50 deletes angle-of-view information from the trajectory queue. The angle-of-view information is deleted from the trajectory queue on the basis of the last-in, first-out (LIFO) rule. Therefore, when the plurality of pieces of angle-of-view information are included in the trajectory queue, the angle-of-view information added to the trajectory queue at the latest timing is deleted in response to the trajectory deletion operation. The angle-of-view information may be deleted from the trajectory queue on the basis of another rule.

In S408, the system control unit 50 determines whether or not another user operation is performed on the operation unit 70. If another user operation is performed, the processing proceeds to S409. Otherwise, the processing proceeds to S410.

In S409, the system control unit 50 performs processing according to the other user operation. For example, the system control unit 50 selects any angle-of-view information included in the trajectory queue, and controls the orientation of the imaging unit 110 to an orientation corresponding to the angle-of-view information.

In S410, the system control unit 50 determines whether or not a user operation (ending operation) for instructing the operation unit 70 to end the trajectory setting processing is performed. If the ending operation is performed, the trajectory setting processing is ended. Otherwise, the processing proceeds to S402.

FIG. 8D is a schematic view illustrating an example of a screen during the trajectory setting processing. A thumbnail image 810 indicating angle-of-view information included in the current trajectory queue is superimposed on the live-view image 801. When the trajectory queue includes a plurality of pieces of angle-of-view information, a plurality of thumbnail images 810 corresponding to the plurality of pieces of angle-of-view information are arranged in the arrangement order of the plurality of pieces of angle-of-view information in the trajectory queue. Note that, at the timing of S401, a state of the trajectory queue may be reset to a state not including the angle-of-view information, or may be a state at the end of the previous trajectory setting processing. Instead of the thumbnail image 810, an icon indicating a number or the like corresponding to a position of the angle-of-view information in the trajectory queue may be displayed. Any information may be displayed as long as the information indicates the set trajectory.

FIG. 5 is a flowchart of the simulation processing performed in S310 of FIG. 3.

In S501, the system control unit 50 initializes a flag, a control variable, or the like. At this time, a GUI (such as an icon) indicating that the simulation processing is in progress may be displayed on the display unit 28.

In S502, the system control unit 50 determines whether one or more pieces of angle-of-view information are included in the trajectory queue (whether or not the trajectory of the angle-of-view change is set). When one or more pieces of angle-of-view information are included in the trajectory queue (the trajectory is set), the processing proceeds to S504. Otherwise, the processing proceeds to S503.

In S503, the system control unit 50 performs preliminary image capturing with an exposure parameter to be applied during main image capturing. For example, the exposure parameter set in S306 of FIG. 3 or the like is used. In a case where automatic exposure processing for each still image capturing is set to be enabled in S308 or the like, the system control unit 50 performs the automatic exposure processing in S503. In the present embodiment, it is assumed that the preliminary image capturing of a still image is performed. The system control unit 50 records a captured image (still image in the present embodiment), obtained by the preliminary image capturing, in a storage medium such as an SD card. The user confirms the still image recorded in the storage medium in S503 in detail (by performing enlargement or the like). The processing of S503 is performed in a case where the main image capturing is the time-lapse image capturing. Since the exposure time of each still image capturing is often long in the time-lapse image capturing, it is important to confirm (in detail) the still image, obtained by the exposure parameter to be applied during the main image capturing, before the time-lapse image capturing. Although the example in which the preliminary image capturing of a still image is performed has been described, the preliminary image capturing of a short moving image (short-time moving image) may be performed.

FIG. 8C illustrates an example of the display screen in S503. In S503, the system control unit 50 records a captured image 804 obtained by the preliminary image capturing in the storage medium, and then displays the captured image 804 on the display unit 28 for a predetermined time. Note that a display time of the captured image 804 may not be limited, and display, non-display, enlargement, reduction, and the like of the captured image 804 may be performed according to a user operation.

In S504, the system control unit 50 changes the angle of view according to the trajectory queue (set trajectory). The exposure of the live-view image displayed at this time is not particularly limited, but it is preferable that the visibility of the live-view image is high and the change in the angle of view is easily confirmed. Therefore, in the present embodiment, it is assumed that the system control unit 50 performs the preliminary image capturing by performing the automatic exposure processing so as to obtain the live-view image (captured image) with appropriate exposure without using the exposure parameter to be applied during the main image capturing. The captured image is not recorded in the storage medium in S504 in order to avoid the pressure on the capacity of the storage medium. The processing of S504 is performed in a case where the main image capturing is the motion time-lapse image capturing. Because the angle-of-view changes during motion time-lapse image capturing, it is important to confirm the change in the angle of view before the motion time-lapse image capturing. Although the example in which the captured image is not recorded in the storage medium has been described in S504, whether or not to record the captured image in the storage unit in S504 may be settable.

FIGS. 8E and 8F illustrate examples of the display screen in S504. A seek bar 811 indicating the progress of the angle-of-view change (a lapse of time of the simulation) is superimposed on a live-view image 805. The seek bar 811 is displayed at the bottom of the screen. The angle of view is changed with the lapse of time. FIG. 8F illustrates a state after FIG. 8E.

As described above, according to the present embodiment, in a case where the trajectory of the change in the angle of view applied during main image capturing is not set (in a case where time-lapse image capturing is performed as the main image capturing), the simulation of performing the preliminary image capturing with the exposure parameter to be applied during main image capturing is executed. Then, in a case where the trajectory is set (in a case where motion time-lapse image capturing is performed as the main image capturing), the simulation of changing the angle of view according to the trajectory is executed. In this way, it is possible to efficiently (suitably) perform the simulation regarding the main image capturing.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

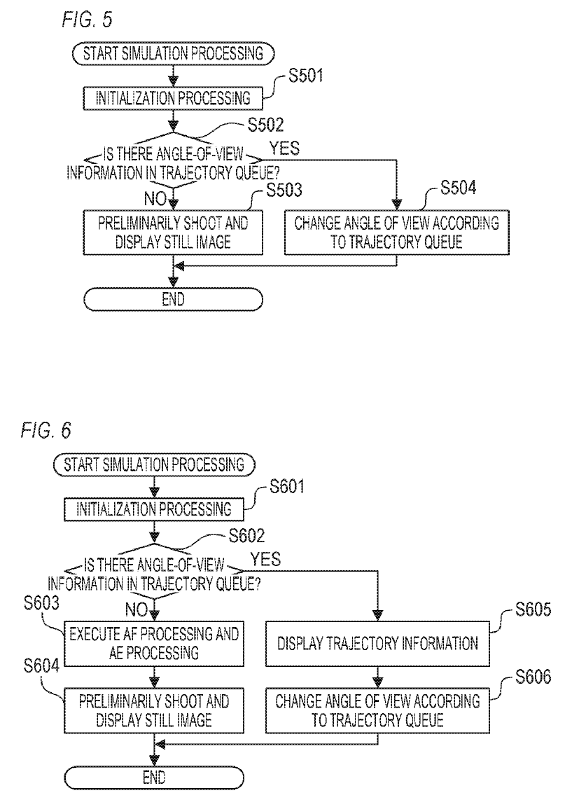

For example, in S310 of FIG. 3, the simulation processing illustrated in FIG. 6 may be performed. Here, it is assumed that the simulation start operation is a pressing of the shutter button 61. Note that the operation member used for the simulation start operation is not limited to the shutter button 61, and may be another operation member capable of two-stage operations such as half-pressing and full-pressing.

In S601, the system control unit 50 initializes a flag, a control variable, or the like. At this time, a GUI (such as an icon) indicating that the simulation processing is in progress may be displayed on the display unit 28.

In S602, the system control unit 50 determines whether one or more pieces of angle-of-view information are included in the trajectory queue (whether or not the trajectory of the angle-of-view change is set). If one or more pieces of angle-of-view information are included in the trajectory queue (the trajectory is set), the processing proceeds to S605. Otherwise, the processing proceeds to S603.

In S603, the system control unit 50 performs at least one of autofocus processing, automatic exposure processing, or automatic white balance processing in response to half-pressing of the shutter button 61 (pressing of the first shutter switch 62). Then, the system control unit 50 displays information regarding such processing on the display unit 28.

FIG. 8B illustrates an example of the display screen in S603. The camera information 802 and an AF frame 809 are superimposed on the live-view image 801. The AF frame 809 indicates a region in which an object is focused by autofocus processing. The camera information 802 includes an exposure parameter such as an F-number (aperture value).

In S604, the system control unit 50 performs the preliminary image capturing with the exposure parameter to be applied during the main image capturing in response to full-pressing of the shutter button 61 (pressing of the second shutter switch 64). Then, the system control unit 50 records a captured image obtained by the preliminary image capturing in the storage medium and displays the captured image on the display unit 28 for a predetermined time.

In S605, the system control unit 50 displays information indicating the set trajectory (trajectory information) on the display unit 28 in response to half-pressing of the shutter button 61 (pressing of the first shutter switch 62). For example, as illustrated in FIG. 8D, the thumbnail image 810 indicating the angle-of-view information included in the current trajectory queue is superimposed on the live-view image 801. Instead of the thumbnail image 810, an icon indicating a number or the like corresponding to a position of the angle-of-view information in the trajectory queue may be displayed. Any information may be displayed as long as the information indicates the set trajectory.

In S606, the system control unit 50 changes the angle of view according to the trajectory queue (set trajectory) in response to full-pressing of the shutter button 61 (pressing of the second shutter switch 64). At this time, the system control unit 50 performs the preliminary image capturing by performing automatic exposure processing so as to obtain a live-view image (captured image) with appropriate exposure without using the exposure parameter to be applied during the main image capturing.

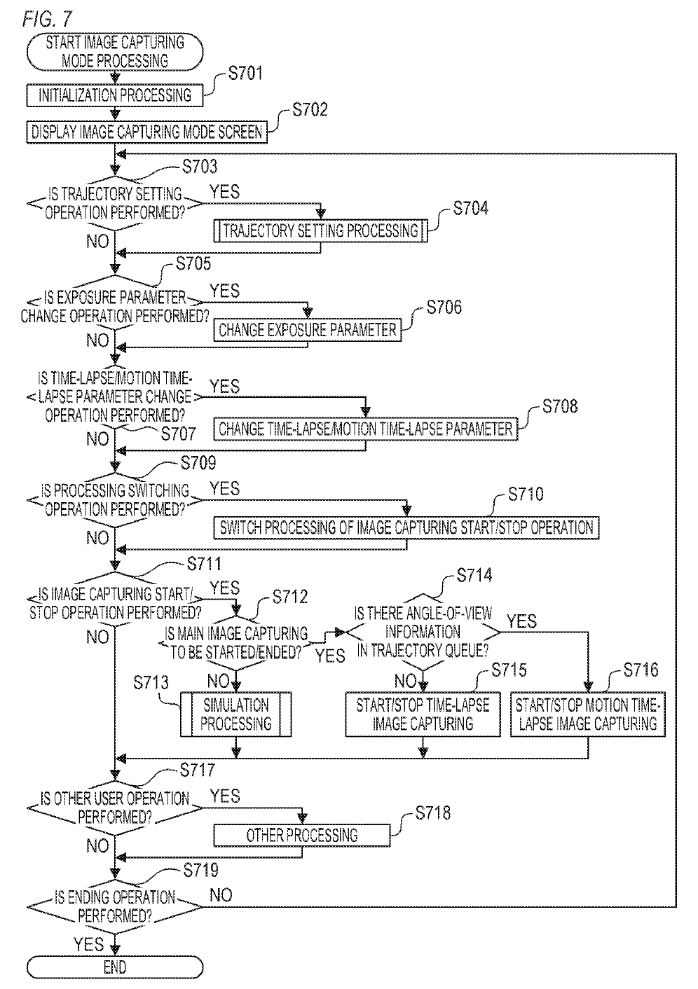

Instead of the image capturing mode processing of FIG. 3, the image capturing mode processing of FIG. 7 may be performed. The simulation start operation and the image capturing start/stop operation are different in FIG. 3, but in FIG. 7, it is assumed that these user operations are the same.

S701 to S708 are the same as S301 to S308 in FIG. 3.

In S709, the system control unit 50 determines whether or not a user operation (processing switching operation) for instructing the operation unit 70 to switch processing to be performed in response to the image capturing start/stop operation is performed. If the processing switching operation is performed, the processing proceeds to S710. Otherwise, the processing proceeds to S711.

In S710, the system control unit 50 switches the processing to be performed in response to the image capturing start/stop operation between the simulation and the start/end of the main image capturing.

In S711, the system control unit 50 determines whether or not the image capturing start/stop operation is performed on the operation unit 70. If the image capturing start/stop operation is performed, the processing proceeds to S712. Otherwise, the processing proceeds to S717.

In S712, the system control unit 50 determines whether or not the start/end of the main image capturing is set as the processing to be performed in response to the image capturing start/stop operation. If the start/end of the main image capturing is set, the processing proceeds to S714. Otherwise (when the simulation is set), the processing proceeds to S713.

In S713, the system control unit 50 performs the simulation processing of FIGS. 5 or 6.

In S714, the system control unit 50 determines whether one or more pieces of angle-of-view information are included in the trajectory queue (whether or not the trajectory of the angle-of-view change is set). If one or more pieces of angle-of-view information are included in the trajectory queue (the trajectory is set), the processing proceeds to S716. Otherwise, the processing proceeds to S715.

In S715, the system control unit 50 starts or stops the time-lapse image capturing. Time-lapse image capturing is started in response to the image capturing start/stop operation in a case where time-lapse image capturing is not being performed, and the time-lapse image capturing is stopped in response to the image capturing start/stop operation in a case where time-lapse image capturing is being performed.

In S716, the system control unit 50 starts or stops the motion time-lapse image capturing. Motion time-lapse image capturing is started in response to the image capturing start/stop operation in a case where motion time-lapse image capturing is not being performed, and the motion time-lapse image capturing is stopped in response to the image capturing start/stop operation in a case where motion time-lapse image capturing is being performed.

S717 to S719 are the same as S315 to S317 in FIG. 3.

The main image capturing performed when the trajectory of the angle-of-view change is not set is not limited to time-lapse image capturing. When the trajectory of the angle-of-view change is not set, another image capturing may be performed with the set exposure parameter. For example, still image capturing may be performed once. The main image capturing performed when the trajectory is set is not limited to motion time-lapse image capturing. When the trajectory is set, another image capturing may be performed while changing the angle of view according to the set trajectory. For example, one panoramic image may be generated by performing still image capturing a plurality of times while changing the angle of view and combining a plurality of still images obtained by the plurality of times of still image capturing.

Although the example in which the digital camera (a gimbal camera in which a camera and a gimbal are integrated) provided with the gimbal mechanism changes the angle of view by driving the drive unit that changes the orientation of the imaging unit has been described, the present disclosure is not limited thereto. For example, the present disclosure may be applied to a wide-range camera (such as a 360° camera capable of image capturing in all directions) having a wide imaging range, and the camera may change an angle of view by changing a range to be used in the imaging range.

The present disclosure is not limited to the gimbal camera or the wide-range camera, and may be applied to a camera mounted on a gimbal or a camera head. In such a configuration, in order to perform motion time-lapse, communication may be performed with the gimbal or the camera head to operate the gimbal or the camera head. The present disclosure may be applied to the gimbal or the camera head. In addition, the present disclosure may be applied to a controller such as a smartphone capable of communicating with the camera, the gimbal, the camera head, or the like.

Although the example in which the simulation is changed or the main image capturing is changed according to whether or not the trajectory of the angle-of-view change is set has been described, other changes may be made. For example, in a case where the trajectory is not set, at least one of the number of times of image capturing or the image capturing interval may be changed from a value set in S308 of FIG. 3 or the like to a value corresponding to time-lapse image capturing. In a case where the trajectory is set, at least one of the image capturing time or the image capturing interval may be changed from the value set in S308 or the like to a value corresponding to motion time-lapse image capturing. In this manner, various parameters may be changed to values suitable for the main image capturing to be performed according to whether or not the trajectory of the angle-of-view change is set.

According to the present disclosure, it is possible to efficiently perform the simulation regarding the main image capturing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An electronic device comprising:
a processor; and
a memory storing a program which, when executed by the processor, causes the electronic device to execute control processing of performing control, in response to a user operation, to execute a simulation regarding main image capturing by an imaging device, wherein
in the control processing, control is performed in response to a first user operation
to execute a first simulation of performing preliminary image capturing with an exposure parameter to be applied during main image capturing in a case where a trajectory of a change in an angle of view of the imaging device applied during the main image capturing is not set, and
to execute a second simulation of changing the angle of view of the imaging device according to the trajectory in a case where the trajectory is set.

2. The electronic device according to claim 1, wherein when the program is executed by the processor, the program further causes the electronic device to execute first setting processing of setting the trajectory.

3. The electronic device according to claim 1, wherein when the program is executed by the processor, the program further causes the electronic device to execute second setting processing of setting the exposure parameter.

4. The electronic device according to claim 1, wherein, in the second simulation, the preliminary image capturing is performed to obtain a captured image with appropriate exposure.

5. The electronic device according to claim 1, wherein,
in the first simulation, a captured image is recorded in a storage, and
in the second simulation, a captured image is not recorded in the storage.

6. The electronic device according to claim 1, wherein,
in the first simulation, a captured image is recorded in a storage, and
whether or not to record a captured image in the storage in the second simulation is settable.

7. The electronic device according to claim 1, wherein, in the first simulation, the preliminary image capturing of a still image is performed.

8. The electronic device according to claim 1, wherein, in the first simulation, the preliminary image capturing of a short moving image is performed.

9. The electronic device according to claim 1, wherein
the first user operation is a user operation of a first operation amount performed on an operation member,
in the control processing, control is performed in response to a second user operation which is a user operation of a second operation amount, smaller than the first operation amount, performed on the operation member
to perform at least one of autofocus processing, automatic exposure processing, or automatic white balance processing in a case where the trajectory is not set, and
to display information indicating the trajectory on a display in a case where the trajectory is set.

10. The electronic device according to claim 1, wherein
in the control processing, control is performed in response to a third user operation
to perform the main image capturing with the exposure parameter without changing the angle of view of the imaging device in a case where the trajectory is not set, and
to perform the main image capturing while changing the angle of view of the imaging device according to the trajectory in a case where the trajectory is set.

11. The electronic device according to claim 10, wherein
when the program is executed by the processor, the program further causes electronic device to execute switching processing of switching processing performed in response to the first user operation between the simulation and the main image capturing, and
the first user operation and the third user operation are an identical user operation.

12. The electronic device according to claim 10, wherein
in the control processing, control is performed in response to the third user operation
to perform time-lapse image capturing as the main image capturing in a case where the trajectory is not set, and
to perform motion time-lapse image capturing as the main image capturing in a case where the trajectory is set.

13. The electronic device according to claim 12, wherein
in the control processing
a value corresponding to the time-lapse image capturing is set as at least one of a number of times or a time interval of still image capturing performed in the main image capturing in a case where the trajectory is not set, and
a value corresponding to the motion time-lapse image capturing is set as at least one of a time for performing the main image capturing or the time interval of the still image capturing performed in the main image capturing in a case where the trajectory is set.

14. The electronic device according to claim 10, wherein
in the control processing, control is performed in response to the third user operation
to perform still image capturing once as the main image capturing in a case where the trajectory is not set, and
to perform still image capturing a plurality of times as the main image capturing while changing the angle of view of the imaging device and combine a plurality of still images obtained by the plurality of times of still image capturing to generate one panoramic image in a case where the trajectory is set.

15. The electronic device according to claim 1, wherein in the control processing, control is performed to change the angle of view of the imaging device by driving a drive processing that changes an orientation of the imaging device.

16. The electronic device according to claim 1, wherein in the control processing, control is performed to change the angle of view of the imaging device by changing a range to be used in an imaging range of the imaging device.

17. A control method of an electronic device, comprising:
receiving a user operation; and
performing control, in response to the user operation, to execute a simulation regarding main image capturing by an imaging device, wherein
control is performed in response to the user operation
to execute a first simulation of performing preliminary image capturing with an exposure parameter to be applied during main image capturing in a case where a trajectory of a change in an angle of view of the imaging device applied during the main image capturing is not set, and
to execute a second simulation of changing the angle of view of the imaging device according to the trajectory in a case where the trajectory is set.

18. A non-transitory computer readable medium that stores a program, wherein the program causes a computer to execute a control method of an electronic device, the control method comprising:
receiving a user operation; and
performing control, in response to the user operation, to execute a simulation regarding main image capturing by an imaging device, wherein
control is performed in response to the user operation,
to execute a first simulation of performing preliminary image capturing with an exposure parameter to be applied during main image capturing in a case where a trajectory of a change in an angle of view of the imaging device applied during the main image capturing is not set, and
to execute a second simulation of changing the angle of view of the imaging device according to the trajectory in a case where the trajectory is set.
